(19) United States
(12) Patent Application Publication
(10) Pub. No.: US 2008/0250707 A1
(43) Pub. Date: Oct. 16, 2008

(54) Method of covering landscaped region with three dimensional fabric having projections

(76) Inventors: Richard M. Grandy, Woodway, TX (US); Clemente Conde, Waco, TX (US)

Correspondence Address: O'KEEFE, EGAN, PETERMAN & ENDERS LLP, 1101 CAPITAL OF TEXAS HIGHWAY SOUTH, #C200, AUSTIN, TX, 78746, US

(21) Appl. No.: 11/786,200

(22) Filed: Apr. 11, 2007

(51) Int. Cl. A01G 1/00

(52) U.S. Cl. 47/9

(57) ABSTRACT

A landscape fabric for covering a landscaping region may be comprised of a three dimensional moisture permeable fabric that has projections extending upward and downward from the fabric. The fabric may prevent the growth of undesirable vegetation, may trap moisture, and may prevent erosion. The fabric can be made of woven materials, non-woven materials, knit materials or the like. The projections in the fabric may be compressible allowing them to return to their shape after being substantially compressed, providing for convenient rolling or folding of the fabric, and easy cutting and manipulation of the fabric.

### TECHNICAL FIELD OF THE INVENTION

The techniques described herein relate to a method of covering a landscaped region of ground with a three dimensional fabric ground cover, and more particularly to a three dimensional fabric ground cover having compressible projections to add in erosion control and moisture retention.

### BACKGROUND

Certain landscape materials or fabrics are used for a variety of landscaping applications, such as deterring growth of undesirable vegetation, providing erosion control, and the like. Landscape fabrics are applied on the landscaped ground, for example on the soil of a landscape bed or other landscape region. Landscape fabrics are often provided in rolls that are unrolled and cut or overlaid to fit the desired placement location. Landscape fabrics may also be delivered in a folded format. Current art landscape fabrics may be made of solid flat plastic sheets, which are undesirable because although they may block weed growth and promote erosion control, the solid plastic sheets do not allow air and water to penetrate the sheet and flow through to the underlying soil. Thus, solid plastic sheets may result in poor growing conditions and mold as the soil is not allowed to “breath” and water is not allowed to reach plant roots.

To address problems with current solid plastic sheet landscape materials, landscape sheet layers have been formed from materials that allow air and water passage but still serve to deter weed growth, provide erosion control, and/or provide other beneficial landscaping properties. Materials allowing air and water passage are often referred to as landscape fabrics although the term landscape fabric as used herein also encompasses other landscape sheeting materials. Landscape fabrics may be formed, for example, from spun bound or woven materials. Exemplary materials include synthetic materials such as polyethylene, polypropylene, polyester, or natural materials. A combination of natural and synthetic materials may also be used. Current art landscape fabrics are typically two dimensional, which allow air and water passage but it is desirable to achieve more effective erosion prevention and moisture retention. Regardless of the type of landscape sheet material used, the landscape sheet materials typically do not have a natural or appealing visual effect for a landscape application. As such, additional materials are often placed on top of the landscape sheet material as part of a complete landscape application. For example, loose organic mulching materials such as bark mulch or nuggets, pine needles, coconut hulls (also called coir), or other organic materials may be placed on top of a landscape sheet after the sheet material has been spread on a landscape area. Unfortunately, these mulching materials are generally bulky, difficult to transport, and difficult to spread.

A current art three dimensional fabric exists and is used for non-landscape applications as outdoor gear, bedding, medical, filtration, household cleaning products, and the like, but has not been used as landscape fabric for covering a landscaped region. The three dimensional fabric is created by deep molding, which can be used with nonwoven, knits, and woven materials. The mold pattern and height are then determined to reach the performance specifications desired. Molds can be designed in various patterns, and can include male/female molding as well. The substrate, pattern, and process parameters of the three dimensional fabric are variables that can be adjusted to increase air flow, improve water absorption, and/or provide greater compression resistance. The patterns are resilient and fabrics are typically lightweight.

### SUMMARY OF THE INVENTION

A landscape fabric for covering a landscaping region may be comprised of a three dimensional moisture permeable fabric that has projections extending in a third dimension relative to a plane of the fabric. The fabric may prevent the growth of undesirable vegetation, may trap moisture, and may prevent erosion. The fabric can be made of woven materials, non-woven materials, knit materials or the like. The projections in the fabric may be compressible allowing them to return to their shape after being substantially compressed, providing for convenient rolling or folding of the fabric, and easy cutting and manipulation of the fabric. The three dimensional fabric may be made of a flexible calendar molded or thermo-formed deep molded non-woven fabric comprising a planar flexible textile non-woven substrate having a multiplicity of compressible projections extending from the planar surface which return to their shape after being substantially compressed. The projections can protrude vertically upward, downward, or both.

In one embodiment, a method of covering a selected landscaping region is described. The method may include providing a three dimensional landscape fabric, the landscape fabric being a two dimensional planar material having projections in a third dimension. The method further includes covering the selected landscape region with the three dimensional landscape, wherein the three dimensional landscape fabric will inhibit growth of undesirable vegetation.

In another embodiment, a landscape fabric for covering a landscaping region may comprise a landscape fabric material that extends in first direction and a second direction, the first and second direction forming a plane of the material. The landscape fabric further comprises projections extending from the landscape material in a third direction to form a three dimensional landscape fabric substantially perpendicular to the plane.

In yet another embodiment, a landscape fabric for covering a landscaping region is also provided. The landscape fabric may comprise a landscape fabric material that extends in first direction and a second direction. The first and second direction may form a plane of the landscape fabric material. The landscape fabric material is water permeable and formed to lessen the growth of undesirable vegetation in the landscaping region. The landscape fabric also includes compressible projections extending from the landscape material in a third direction substantially perpendicular to the plane, the compressible projections forming pockets that provide erosion protection or moisture trapping.

### DESCRIPTION OF THE DRAWINGS

It is noted that the appended drawings illustrate only exemplary techniques described herein and are, therefore, not to be considered limiting of its scope, for the techniques may admit to other equally effective embodiments.

FIG. 1A shows a top view of a three dimensional landscape fabric ground cover;

FIG. 1B shows a cross-sectional view of a three dimensional landscape fabric ground cover with upward projections;

FIG. 1C shows a cross-sectional view of the three dimensional landscape fabric ground cover with upward and downward projections;

FIG. 2A shows a top view of a three dimensional landscape fabric ground cover;

FIG. 2B shows a perspective view of the three dimensional landscape fabric ground cover;

FIG. 3 shows a cross-sectional view of the three dimensional landscape fabric ground cover in use.

FIG. 4 shows a perspective view of a three dimensional landscape fabric.

### DETAILED DESCRIPTION OF THE INVENTION

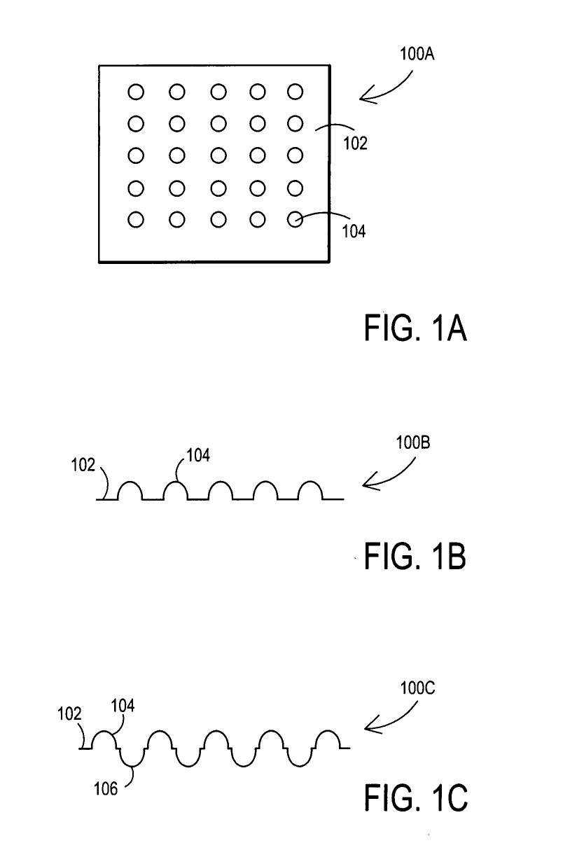

The techniques described herein provide a method of covering a landscaped region oil landscaped ground comprising selecting a portion of said landscaped ground wherein undesirable vegetation is to be prevented, and covering the selected portion with a moisture permeable ground cover made of a three dimensional fabric having projections. Referring to the drawings, FIG. 1A shows a top view of a three dimensional landscape fabric 100A. In FIG. 1A, projections 104 are shown on the three dimensional landscape fabric 102. These projections 104 can protrude vertically upward and/or downward as shown in FIGS. 1B and 1C. FIG. 1B shows a cross-sectional side view of the three dimensional landscape fabric 100B. The projections 104 shown in FIG. 1B protrude vertically upward from the landscape fabric 102. In FIG. 1C, a cross-sectional side view of a three dimensional landscape sheet 100C is shown having upward projections 104 extending upward and downward projections 106 extending downward from the landscape fabric 102.

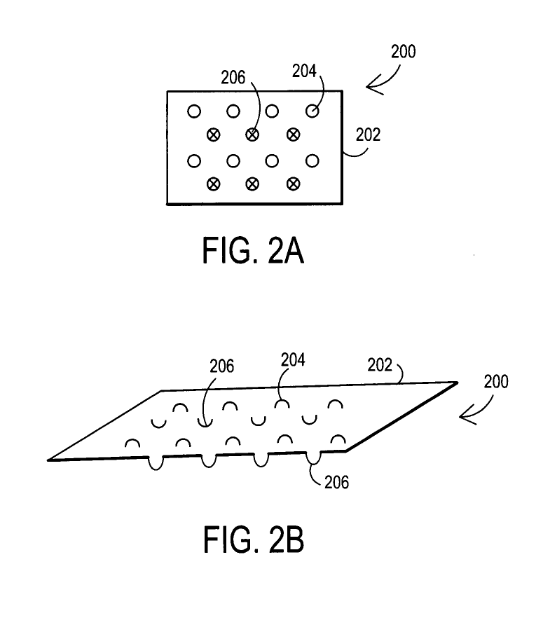

FIG. 2A shows a top view of another three dimensional landscape fabric ground cover 200. The three dimensional fabric sheet 202 has upward projections 204 and downward projections 206. The three dimensional fabric sheet 202 covers a landscaped region on a landscaped ground after a user selects a portion of the landscaped ground wherein undesirable vegetation is to be prevented. In use, the user covers the selected portion of the landscaped ground with the three dimensional landscape fabric ground cover 200 which is a moisture permeable ground cover.

The three dimensional fabric sheet 202 has projections, which can be either upward projections 204 extending vertically upward, downward projections 206 extending vertically downward, or both. The projections 204, 206 can be compressible, allowing for easy folding or rolling of the fabric, as well as easy cutting and manipulation of the fabric sheet 202 in use. The three dimensional fabric ground cover 200 prevents erosion and provides a mechanism for trapping and retaining moisture in the pockets formed by the projections. As shown in FIG. 2A, the upward projections 204 and the downward projections 206 may be formed in an alternating pattern. The three dimensional landscape fabric ground cover 200 can be made of a flexible calendar molded or thermo-formed deep molded non-woven fabric comprising a planar flexible textile non-woven substrate having a multiplicity of compressible projections 204, 206 extending from a planar surface which return to their shape after being substantially compressed. The three dimensional landscape fabric ground cover 200 can also be made of woven or knit materials.

FIG. 2B shows a perspective view of the three dimensional landscape fabric ground cover 200. The three dimensional fabric sheet 202 has upward projections 204 and downward projections 206. The three dimensional landscape fabric ground cover 200A may comprise a three dimensional fabric sheet 202 wherein the fabric sheet 202 extends in a first direction and a second direction, the first and second direction forming a plane in the fabric, further having projections 204 extending in a third direction substantially perpendicular to the plane. The three dimensional landscape fabric ground cover 200 can also have projections 206 extending in a fourth direction substantially perpendicular to the plane. As shown in the figures, the three dimensional landscape fabric ground cover 200 may be essentially planar in the regions other than the projection regions. The three dimensional landscape fabric ground cover 200 may be created by deep molding, which can be used with nonwoven, knits, and woven materials. The mold pattern and height are may be adjusted to the desired size of the projections. Molds can be designed in various patterns, and can include male/female projections as well. The substrate, pattern, and process parameters of the three dimensional landscape fabric ground cover 200 are variables that can be adjusted to increase air flow, improve water absorption, and/or provide greater compression resistance. The patterns are resilient and fabrics are typically lightweight.

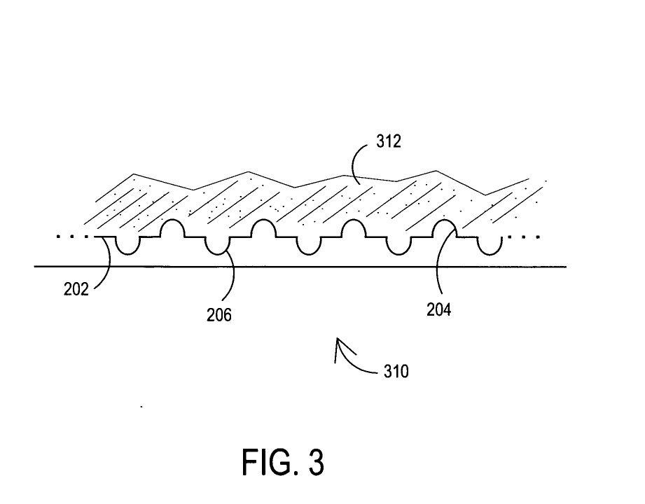

FIG. 3 shows a side view of the three dimensional landscape fabric ground cover 200 in use. A user covers a landscaped region of the ground 310 by selecting a portion or region of the landscaped ground 310 wherein undesired vegetation is to be prevented. The user may covers the selected portion or region with a moisture permeable three dimensional landscape fabric ground cover 200 preventing growth of the undesired vegetation. The three dimensional landscape fabric ground cover 200 has compressible projections 204 and 206 which can extend vertically upward and vertically downward. The projections may assist in controlling the erosion of the ground 310 underneath the three dimensional landscape fabric ground cover 200. In addition, the projections may also assist in controlling the erosion of an upper layer 312 of soil, mulch or the like that is placed on top of the ground cover. The three dimensional landscape fabric ground cover 200 may also trap moisture in the projections 204 and 206. Thus due to the three dimensional and water trapping nature of the projections, erosion and water run-off is lessened.

The surface of the landscape sheet 202 and projections 204 and 206 may also be textured to assist the functional features of the ground cover. The texture may be formed as part of the deep molding, insuring long-lasting performance. Since it is made from ultra-heavy spun fibers, the ground cover 200 may have beneficial weed-stopping power to keep landscapes free from weeds. The ground cover 200 can also be made of woven or knit material. In one embodiment, the three dimensional landscape fabric ground cover may be formed of a nonwoven NOVOLON™ Dimensional Fabric available from Novolon of Durham N.C., a division of Freudenberg LP. The concepts described herein are not limited to such a fabric and other fabrics and materials may be utilized while still obtaining the benefits described herein.

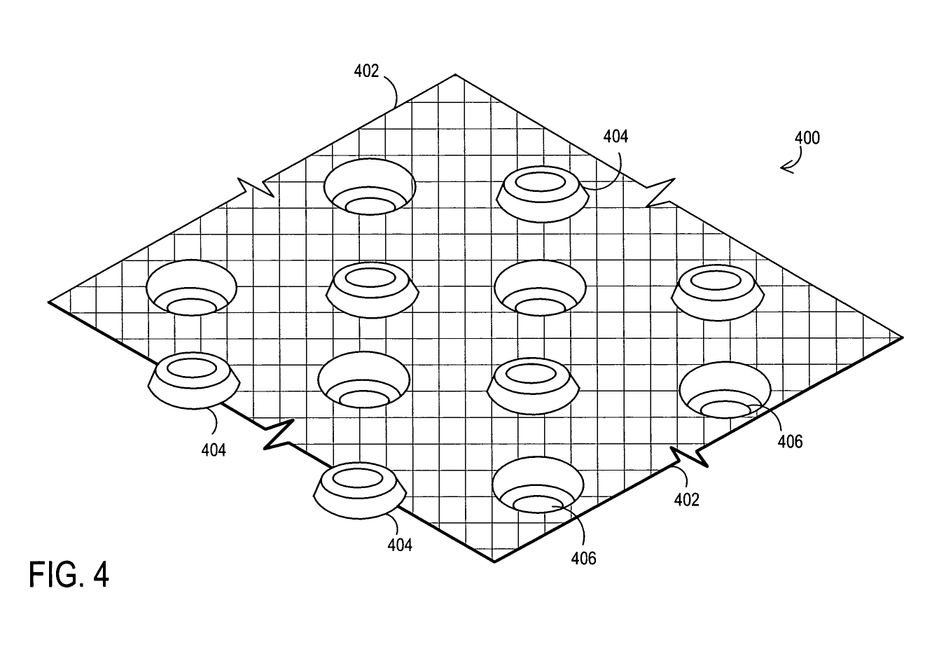

FIG. 4 shows a more detailed view of one exemplary landscape fabric ground cover 400 as described herein. As shown in FIG. 4, the landscape fabric ground cover 400 may be formed of a sheet like two-dimensional portion 402 that includes projections 404 and 406. It will be recognized that the patterns of projections and the shapes of the projections shown herein are merely exemplary and many other patterns and shapes may be utilized. As shown in FIG. 4, the landscape fabric ground cover 400 is substantially planar in two dimensions except for the projections 404 and 406 which extend in a third dimension. In one embodiment, the thickness of the relatively planar region may be approximately 1 mm and more preferable less than 1 mm. The projections may range in height from approximately 2 mm to 5.4 mm and more preferable be from 3 to 4.4 mm in height. Thus, as shown and described the landscape fabric may be substantially (relatively) planar in two dimensions with projections extending in a third dimension to form a three dimensional landscape fabric.

As mentioned above, the projections formed in the landscape fabric ground covers described herein may be compressible. The compressible nature of the projections allows the ground cover to be more conveniently packaged for transport and point of sale display. For example, the compressible nature of the projections allows rolls of the landscape fabric ground to be provided with a decreased volume.

Further modifications and alternative embodiments of the techniques described herein will be apparent to those skilled in the art in view of this description. It will be recognized, therefore, that the techniques described herein are not limited by these example arrangements. Accordingly, this description is to be construed as illustrative only and is for the purpose of teaching those skilled in the art the manner of carrying out the techniques. It is to be understood that the forms of the techniques described herein shown and described are to be taken as the presently preferred embodiments. Various changes may be made in the implementations and architectures. For example, equivalent elements may be substituted for those illustrated and described herein, and certain features of the invention may be utilized independently of the use of other features, all as would be apparent to one skilled in the art after having the benefit of this description of the techniques.

What is claimed is:

1. A method of covering a selected landscaping region, comprising:
providing a three dimensional landscape fabric, the landscape fabric being a two dimension planar material having projections in a third dimension; and
covering the selected landscape region with the three dimensional landscape;
wherein the three dimensional landscape fabric will inhibit growth of undesirable vegetation.

2. The method of claim 1, wherein the projections extend vertically upward.

3. The method of claim 1, wherein the projections extend vertically downward.

4. The method of claim 1, wherein the projections extend both vertically upward and downward.

5. The method of claim 1, wherein the three dimensional landscape fabric is moisture permeable.

6. The method of claim 6, wherein the projections trap moisture.

7. The method of claim 1, wherein the ground cover prevents erosion.

8. The method of claim 1, wherein the projections are compressible.

9. The method of claim 8, wherein the projections extend vertically upward.

10. The method of claim 8, wherein the projections extend vertically downward.

11. The method of claim 8, wherein the projections extend both vertically upward and downward.

12. The method of claim 9, wherein the three dimensional landscape fabric is moisture permeable.

13. The method of claim 8, wherein the three dimensional fabric is made of nonwoven material.

14. The method of claim 8, wherein the three dimensional fabric is made of woven material.

15. The method of claim 8, wherein the three dimensional fabric is made of knit material.

16. The method of claim 1, wherein the three dimensional fabric is a flexible calendar molded or thermo-formed deep molded non-woven fabric comprising a planar flexible textile non-woven substrate having a multiplicity of compressible projections extending from the planar surface which return to their shape after being substantially compressed.

17. The method of claim 16, wherein the projections extend both vertically upward and downward.

18. A landscape fabric for covering a landscaping region, comprising:
a landscape fabric material that extends in first direction and a second direction, the first and second direction forming a plane of the material; and
projections extending from the landscape material in a third direction to form a three dimensional landscape fabric substantially perpendicular to the plane.

19. The landscape fabric of claim 18, further having projections extending in a fourth direction substantially perpendicular to the plane.

20. The landscape fabric of claim 19, wherein a plurality of the projections are compressible.

21. The landscape fabric of claim 18, wherein a plurality of the projections are compressible.

22. The landscape fabric of claim 18, wherein the landscape fabric material is made of a flexible calendar molded or thermo-formed deep molded non-woven fabric comprising a planar flexible textile non-woven substrate having a multiplicity of compressible projections extending from the planar surface which return to their shape after being substantially compressed.

23. The landscape fabric of claim 22, further having projections extending in a fourth direction substantially perpendicular to the plane formed by the first and second directions.

24. The landscape fabric of claim 18, wherein the fabric is made of a nonwoven material.

25. The landscape fabric of claim 18, wherein the fabric is made of a woven material.

26. The landscape fabric of claim 18, wherein the fabric is made of a knit material.

27. A landscape fabric for covering a landscaping region, comprising:
a landscape fabric material that extends in first direction and a second direction, the first and second direction forming a plane of the landscape fabric material, the landscape fabric material being water permeable and formed to lessen the growth of undesirable vegetation in the landscaping region; and
compressible projections extending from the landscape material in a third direction substantially perpendicular to the plane, the compressible projections forming pockets that provide erosion protection or moisture trapping.

28. The landscape fabric of claim 27, wherein the compressible projections provided both erosion protection and moisture trapping.

29. The landscape fabric of claim 28, wherein the compressible projections extend both upward and downward with relation to the plane of the landscape fabric material.

30. The landscape fabric of claim 29, the landscape material being a nonwoven material.

31. The landscape fabric of claim 27, the landscape material being a nonwoven material.

32. The landscape fabric of claim 27, wherein the fabric is made of a woven material.

33. The landscape fabric of claim 27, wherein the fabric is made of a knit material.
